(19) United States
(12) Patent Application Publication
(10) Pub. No.: US 2017/0126034 A1
(43) Pub. Date: May 4, 2017

(54) BATTERY OVERCHARGE SAFETY SYSTEM

(71) Applicant: Hyundai Motor Company, Seoul (KR)

(72) Inventor: Dal Kim, Gyeonggi-do (KR)

(21) Appl. No.: 15/215,173

(22) Filed: Jul. 20, 2016

(30) Foreign Application Priority Data
Nov. 3, 2015 (KR) 10-2015-0153563

(51) Int. Cl. H02J 7/00; H01M 10/44; H01M 10/42

(52) U.S. Cl. CPC H02J 7/0029; H02J 7/0091; H01M 10/425; H01M 10/443; H01M 10/445; H02J 2007/0037; H01M 2220/20; H01M 2200/10; H01M 2200/20; H01M 2010/4271

(57) ABSTRACT

A battery overcharge safety system of a passive control method is provided which uses a Zener diode and a neutral material to prevent a battery mounted in an eco-friendly vehicle from being overcharged. More particularly, the battery overcharge safety system prevents a battery mounted in an eco-friendly vehicle from being overcharged using a Zener diode which generates heat when the battery is overcharged and a neutral material which is vaporized and expands by the heat generated in the Zener diode to operate an overcharge preventing switch.

### CROSS-REFERENCE TO RELATED APPLICATION

This application claims under 35 U.S.C. §119(a) the benefit of Korean Patent Application No. 10-2015-0153563 filed on Nov. 3, 2015, the entire contents of which are incorporated herein by reference.

### BACKGROUND

(a) Technical Field

The present disclosure relates to a battery overcharge safety system, and more particularly, to a battery overcharge safety system of a passive control method which prevents a battery mounted in an eco-friendly vehicle from being overcharged, using a Zener diode and a neutral material.

(b) Background Art

A battery in a normal state which is mounted in an eco-friendly vehicle, such as an electric vehicle and a hybrid vehicle, is managed within a state of charging (SOC) 100% region and contributes to a power performance of the eco-friendly vehicle. However, when the battery is overcharged, as illustrated in FIG. 1 of the related art, a battery voltage is gradually increased to SOC 100%, the battery voltage is rapidly increased over SOC 100% and a battery temperature is also increased. Therefore, when an electrolyte in a battery pouch is gasificated and a sealing unit of the battery pouch is opened, the electrolyte leaks to the outside.

When the electrolyte leaks from the battery pouch, the battery is ignited by a spark caused by a short circuit in a battery cell or a spark caused by an external factor and the battery ignition results in fire of a vehicle, which may cause various damages such as an injury to a person. Currently, an SOC of a battery is managed using a voltage as a main parameter and a principal management agent is a controller known as a battery management system (BMS).

A method in which the controller actively and automatically adjusts the SOC of the battery is referred to as an active control method and when a controller for the active control method has a malfunction or failure, the battery is overcharged, which may cause a fire. In contrast, a method which prevents the battery from being overcharged using a mechanical and electric device even when the controller has failed is referred to as a passive control method. Accordingly, to safely manage the battery of the eco-friendly vehicle, it is desirable to prevent the battery from being overcharged using the passive control method in addition to the active control method.

The above information disclosed in this section is merely for enhancement of understanding of the background of the invention and therefore it may contain information that does not form the prior art that is already known in this country to a person of ordinary skill in the art.

### SUMMARY

The present invention provides a battery overcharge safety system of a passive control method which prevents a battery mounted in an eco-friendly vehicle from being overcharged, using a Zener diode configured to generate heat when the battery is overcharged and a neutral material which is vaporized and expands by the heat generated in the Zener diode to operate an overcharge preventing switch.

In one aspect, the present invention provides a battery overcharge safety system that may include: a heating unit conductively connected to a battery to generate heat at a predetermined voltage or greater of the battery when a battery is overcharged; an expanding unit that expands by the heating unit; and an overcharge preventing switch pressed when the expanding unit expands to turn off a main relay mounted in a battery charging line.

In an exemplary embodiment, a Zener diode may be used as the heating unit and may be conductively connected to the battery. In addition, when the battery voltage increases to a predetermined voltage or greater to be equal to or greater than a critical voltage of the Zener diode, a current from the battery may be applied to the Zener diode and the Zener diode may be configured to generate heat.

In another aspect according to the present invention, the expanding unit may be composed of a neutral material which is vaporized at a predetermined temperature or greater and an elastomer which expands when the neutral material is vaporized in a state where the neutral material is sealed therein to press the overcharge preventing switch. In addition, Freon gas may be used as the neutral material. The elastomer may be provided in the form of a rubber bag.

Through the aforementioned technical solutions, the present invention provides the effects below.

According to the present invention, it may be possible to prevent the battery from being overcharged and fire caused by the overcharged battery, using the passive control method in addition to the active control method for preventing the battery of the eco-friendly vehicle from being overcharged. In other words, a passive control method which operates a battery overcharge preventing switch using a Zener diode and a neutral material may be applied to prevent the overcharge of the battery and fire.

### BRIEF DESCRIPTION OF THE DRAWINGS

The above and other features of the present invention will now be described in detail with reference to exemplary embodiments thereof illustrated in the accompanying drawings which are given hereinbelow by way of illustration only, and thus are not limitative of the present invention, and wherein:

FIG. 1 is a graph illustrating a battery overcharging range according to the related art;

FIG. 2 is a configurational view for battery charging according to an exemplary embodiment of the present invention;

FIG. 3 is a configurational view illustrating a battery overcharge safety system according to an exemplary embodiment of the present invention; and

FIG. 4 is a flowchart illustrating an operating flow of a battery overcharge safety system according to an exemplary embodiment of the present invention.

Reference numerals set forth in the Drawings includes reference to the following elements as further discussed below.
10: battery
12: battery charging line
14: main relay
16: overcharge preventing switch
18: zener diode
20: neutral material
22: elastomer

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, an exemplary embodiment of the present invention will be described in detail with reference to the accompanying drawings.

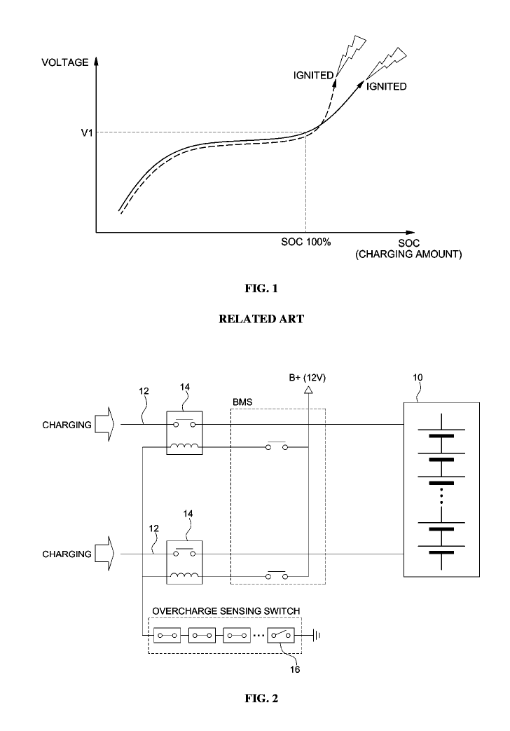

A battery mounted within an eco-friendly vehicle may be a high voltage battery in which a plurality of battery cells are configured in the form of a module or a pack and may collectively be referred to as a battery, for more understanding of the present invention. FIG. 2 is a configurational view for battery charging and reference numeral 10 denotes a battery. A battery charging line 12 may be connected to the battery 10 and a main relay 14 turned on to charge the battery and turned off to stop charging may be connected to the battery charging line 12.

In particular, the on and off control of the main relay 14 may be executed by a battery management system (BMS) controller which uses a 12 V auxiliary battery power supply. An overcharge preventing switch 16 pressed at a predetermined pressure or greater may be connected to the main relay 14. When the battery is overcharged, the overcharge preventing switch 16 may be configured to disconnect the 12 V power supply connected to the main relay 14 to turn off the main relay 14.

When a swelling phenomenon, in which a battery pouch expands, occurs due to gasification of an electrolyte caused by the overcharged battery, the overcharge preventing switch 16 may be pressed by a swelling pressure. However, the overcharge preventing switch 16 may not be smoothly pressed due to an irregular swelling amount or swelling pressure. Therefore, a device for completely pressing the overcharge preventing switch 16 when the battery is overcharged is required.

In other words, a device for sufficiently pressing the overcharge preventing switch when the battery is overcharged is required. Accordingly, when the battery is overcharged, a heating unit configured to generate heat at a predetermined voltage or greater may be conductively connected to the battery and an expanding unit that expands by the heating unit to press the overcharge preventing switch may be disposed adjacent to the heating unit.

Further, a Zener diode 18 conductively connected to the battery 10 may be employed as the heating unit and the Zener diode 18 may be configured to generate heat while allowing a current to flow at a predetermined voltage. For example, since a voltage may be about 5 V or greater when the battery is overcharged, the Zener diode 18 connected to the battery 10 may be configured to generate heat while allowing the battery current to flow at a voltage of about 5 V.

The expanding unit may include a neutral material 20 vaporized at a predetermined temperature or greater and an elastomer 22 that expands when the neutral material is vaporized when the neutral is sealed therein to press the overcharge preventing switch 16, and may be disposed adjacent to the Zener diode 18. Further, the neutral material 20 may be Freon gas which is in a liquid state at a room temperature and is vaporized at a boiling point of 92.8° C. and the elastomer 22 may be provided in the form of a rubber bag which is airtightly (e.g., airtight seal) filled with liquid state Freon gas and expands when the Freon gas is vaporized.

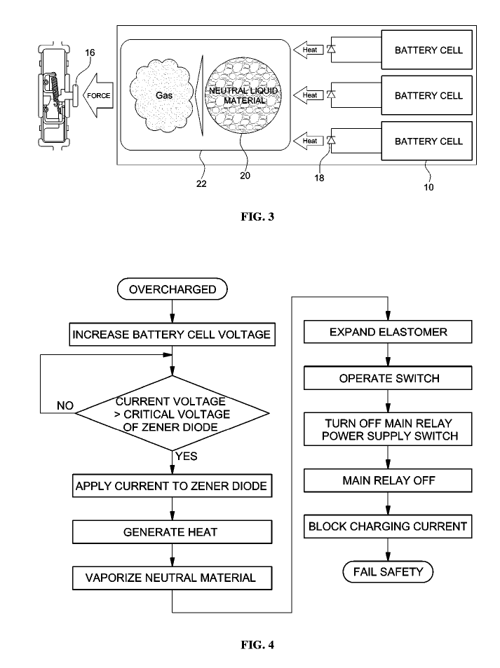

In particular, an operating flow of the battery overcharge safety system configured as described above will be described with reference to FIGS. 3 and 4. The battery voltage may gradually increase as the battery 10 is charged and when the battery is overcharged, the battery voltage may increase to a predetermined voltage or greater (e.g., about 5 V or greater). When the battery voltage increases to the predetermined voltage or greater to be equal to or greater than a critical voltage of the Zener diode 18, a current may be applied from the battery 10 to the Zener diode 18 and the Zener diode 18 may be configured to generate heat. In particular, heat of the Zener diode may be transmitted to the neutral material 20 of the expanding unit disposed adjacent to the Zener diode 18 to vaporize the neutral material 20.

Further, the neutral material 20 may be continuously vaporized, causing the elastomer 22 which seals the neutral material 20 to expand to press the overcharge preventing switch 16. Therefore, the overcharge preventing switch 16 may be pressed to cause a 12 V auxiliary battery power supply line to be a short circuit and the 12 V auxiliary battery power supplied to the main relay 14 may be blocked. As a result, the main relay 14 may be turned off, thereby blocking a battery charging current which flows into the battery.

As described above, a passive control method which completely operates a battery overcharge preventing switch using a Zener diode and a neutral material when the battery is overcharged may be applied to fundamentally prevent the overcharge of the battery and fire caused thereby.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A battery overcharge safety system, comprising:
a heating unit connected to a battery to generate heat at a predetermined voltage or greater of the battery;
an expanding unit that expands by the heating unit; and
an overcharging preventing switch pressed when the expanding unit expands to turn off a main relay mounted in a battery charging line.

2. The system of claim 1, wherein a Zener diode is used as the heating unit and conductively connected to the battery.

3. The system of claim 2, wherein when the battery voltage increases to a predetermined voltage or greater to be equal to or greater than a critical voltage of the Zener diode, a current from the battery is applied to the Zener diode and the Zener diode generates heat.

4. The system of claim 1, wherein the expanding unit is composed of a neutral material which is vaporized at a predetermined temperature or greater and an elastomer which expands when the neutral material is vaporized in a state where the neutral material is sealed therein to press the overcharge preventing switch.

5. The system of claim 4, wherein Freon gas as the neutral material.

6. The system of claim 4, wherein the elastomer is provided in the form of a rubber bag.

7. The system of claim 4, wherein the heat of a Zener diode used as the heating unit is transmitted to the neutral material of the expanding unit disposed adjacent to the Zener diode to vaporize the neutral material.
